(19) United States
(12) Patent Application Publication
(10) Pub. No.: US 2025/0145389 A1
(43) Pub. Date: May 8, 2025

(54) ACTUATOR AND MAGNETIC POLE POSITION ESTIMATION METHOD

(71) Applicant: THK CO., LTD., Tokyo (JP)

(72) Inventors: Katsuya Fukushima, Minato-ku, Tokyo (JP); Shogo Wakuta, Minato-ku, Tokyo (JP); Satoshi Hara, Minato-ku, Tokyo (JP); Masashi Ishii, Minato-ku, Tokyo (JP); Taichi Maeda, Minato-ku, Tokyo (JP)

(73) Assignee: THK CO., LTD., Tokyo (JP)

(21) Appl. No.: 18/837,390

(22) PCT Filed: Feb. 6, 2023
(86) PCT No.: PCT/JP2023/003816

§ 371 Date: Aug. 9, 2024

(30) Foreign Application Priority Data
Feb. 15, 2022 (JP) 2022-021622

(51) Int. Cl. B65G 47/91

(52) U.S. Cl. CPC B65G 47/91

(57) ABSTRACT

An actuator includes a linear motion motor that moves a mover relative to a stator to move a shaft in an axial direction of the shaft, a brake device that brakes the movement of the shaft in the axial direction, and a force sensor that detects a direction of a force acting on the mover in the axial direction of the shaft. Then, in the actuator, an estimator estimates a magnetic pole position of the mover, based on the direction of the force detected by the force sensor when the linear motion motor is energized in a stopped state of the movement of the shaft in the axial direction by the brake device.

### TECHNICAL FIELD

The present invention relates to an actuator that performs a pick-and-place operation.

### BACKGROUND ART

Conventionally, an actuator is known that performs a series of operation (a pick-and-place operation) of picking up a workpiece with a shaft and placing the picked-up workpiece at a predetermined position with the shaft. In the actuator that performs the pick-and-place operation, the workpiece is sucked to a tip of a hollow shaft and picked up by applying a negative pressure to an interior of the shaft while the tip of the hollow shaft is pressed onto the workpiece.

Also, Patent Document 1 discloses a technology for estimating a magnetic pole position of a mover of a linear motor in a linear actuator. In the technology disclosed in Patent Document 1, a section where the mover is located is estimated based on a moving direction of the mover in each of first pulse energization and second pulse energization that are continuous.

### CITATION LIST

### Patent Document

[Patent Document 1] Japanese Patent No. 6191086

### SUMMARY OF THE INVENTION

### Technical Problem

In an actuator that performs a pick-and-place operation of a workpiece by moving a shaft in an axial direction of the shaft, it is necessary to grasp a position of a mover in a linear motion motor that moves the shaft for controlling a position of the shaft in the axial direction. In the linear motion motor, however, an absolute position of the mover may not be detected. At start of energization to the actuator (at the start of the energization to the linear motion motor), for grasping a magnetic pole position of the mover in the linear motion motor, the mover may be moved by once performing excitation to generate a moving magnetic field.

However, when the linear motion motor is energized in an unknown state of the magnetic pole position of the mover, the moving magnetic field may be generated in an unknown state of whether the shaft moves upward or downward. As a result of the excitation for grasping the magnetic pole position of the mover, there may be, for example, a problem that as the shaft moves, the shaft contacts a workpiece that is ready to be picked up.

An object of the present invention, which has been made in view of such problems as described above, is to provide a technology capable of grasping a magnetic pole position of a mover in a linear motion motor without moving a shaft in an actuator.

### Solution to Problem

An actuator according to a first aspect of the present invention is an actuator that sucks a workpiece to a tip of a shaft to pick up the workpiece, the actuator including:
a linear motion motor including a stator and a mover, the shaft being connected to the mover, the mover moving relative to the stator to move the shaft in an axial direction of the shaft,
a brake device that brakes the movement of the shaft in the axial direction,
a force sensor that detects a direction of a force acting on the mover in the axial direction of the shaft, and
an estimator configured to estimate a magnetic pole position of the mover, based on the direction of the force detected by the force sensor when the linear motion motor is energized in a stopped state of the movement of the shaft in the axial direction by the brake device.

A position estimation method according to a second aspect of the present invention is a position estimation method of estimating a magnetic pole position of a mover in an actuator that sucks a workpiece to a tip of a shaft to pick up the workpiece, the actuator including:
a linear motion motor including a stator and a mover, the shaft being connected to the mover, the mover moving relative to the stator to move the shaft in an axial direction of the shaft,
a brake device that brakes the movement of the shaft in the axial direction, and
a force sensor that detects a direction of a force acting on the mover in the axial direction of the shaft,
the position estimation method including:
estimating the magnetic pole position of the mover, based on the direction of the force detected by the force sensor when the linear motion motor is energized in a stopped state of the movement of the shaft in the axial direction by the brake device.

### Effects of the Invention

According to the present invention, it is possible to grasp a magnetic pole position of a mover in a linear motion motor without moving a shaft in an actuator.

### BRIEF DESCRIPTION OF THE DRAWINGS

FIG. 1 is an appearance view of an actuator according to an embodiment.

FIG. 2 is a schematic configuration view illustrating an inner structure of the actuator according to the embodiment.

FIG. 3 is a cross-sectional view illustrating a schematic configuration including a shaft housing and a tip of a shaft according to the embodiment.

FIG. 4 is an image diagram for explaining a method of estimating a magnetic pole position of a mover in a linear motion motor according to the embodiment.

FIG. 5 is a flowchart illustrating a flow of processing for estimating the magnetic pole position of the mover in the linear motion motor according to the embodiment.

### MODE FOR CARRYING OUT THE INVENTION

An actuator according to the present invention sucks a workpiece to a tip of a shaft to pick up the workpiece. The actuator includes a linear motion motor, a brake device, a force sensor, and an estimator.

The linear motion motor is a motor that moves the shaft in an axial direction of the shaft. The linear motion motor includes a stator and a mover. The shaft is connected to the mover. Then, as the mover moves relative to the stator, the shaft moves together with the mover. The brake device is a device that brakes the movement of the shaft in the axial direction. In the actuator, the brake device can stop the movement of the shaft in the axial direction.

The force sensor detects a direction of a force acting on the mover in the axial direction of the shaft. Specifically, in the actuator, the force sensor detects whether an upward or downward force acts on the mover. Note that as a configuration of the force sensor, a configuration including a strain gauge can be illustrated.

A controller estimates a magnetic pole position of the mover in the linear motion motor in a stopped state of the movement of the shaft in the axial direction by the brake device at the start of energization to the linear motion motor. Specifically, the controller energizes the linear motion motor in the stopped state of the movement of the shaft in the axial direction by the brake device. At this time, the controller performs the energization to the linear motion motor to attract the mover to a predetermined target position by a moving magnetic field generated in the linear motion motor. Since the movement of the shaft in the axial direction is stopped by the brake device, the mover connected to the shaft does not actually move even if the moving magnetic field is generated in the linear motion motor.

However, a force in the axial direction of the shaft acts on the mover. Specifically, if the controller performs the energization to the linear motion motor with the mover located above the predetermined target position, the downward force acts on the mover due to the moving magnetic field. On the other hand, if the controller energizes and excites the linear motion motor with the mover located below the predetermined target position, the upward force acts on the mover due to the moving magnetic field.

In the present invention, the estimator estimates the magnetic pole position of the mover based on the direction of the force detected by the force sensor. Specifically, if the downward force acts on the mover, the estimator estimates that the mover is located above the predetermined target position in the energization to the linear motion motor. If the upward force acts on the mover, the estimator estimates that the mover is located below the predetermined target position in the energization to the linear motion motor.

Therefore, according to the present invention, in the actuator, it is possible to grasp the magnetic pole position of the mover in the linear motion motor without moving the shaft in the actuator.

Hereinafter, a specific embodiment of the present disclosure will be described with reference to the drawings. A dimension, material, shape, relative arrangement, and the like of any component described in the present embodiment are not intended to restrict the technical scope of the present disclosure unless otherwise described.

### Embodiment

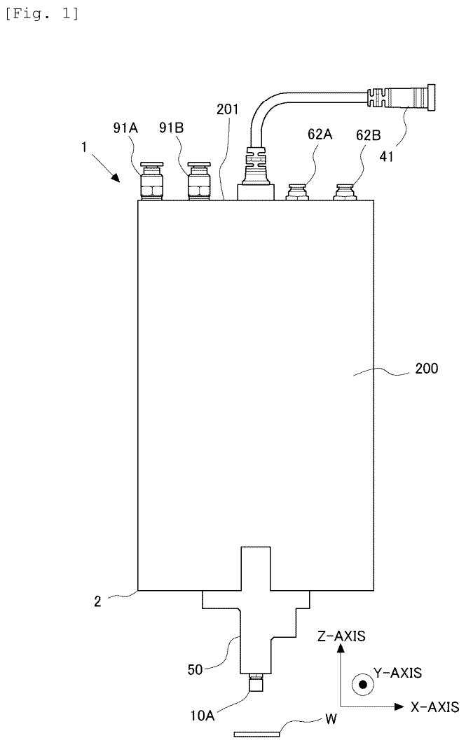

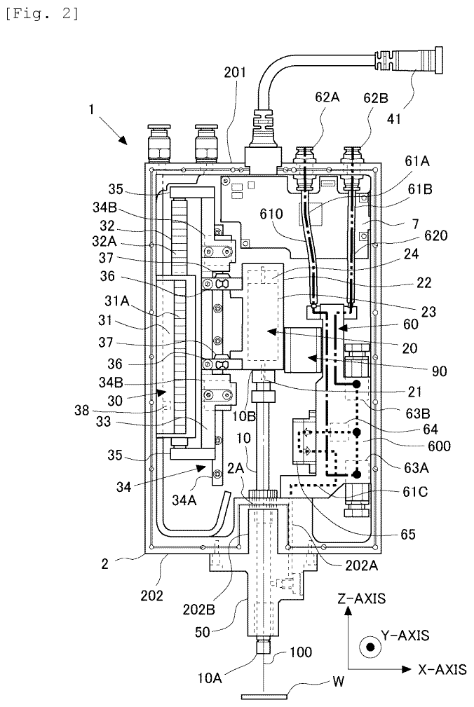

FIG. 1 is an appearance view of an actuator 1 according to the present embodiment. The actuator 1 includes a housing 2 having a substantially rectangular parallelepiped outer shape, and a lid 200 is attached to the housing 2. FIG. 2 is a schematic configuration view illustrating an inner structure of the actuator 1 according to the present embodiment. A part of a shaft 10 is housed within the housing 2. The shaft 10 is formed to be hollow on a tip 10A side. In a material of the shaft 10 and the housing 2, for example, a metal (e.g., aluminum) may be used, or a resin or the like may be used. Note that in the following description, an XYZ orthogonal coordinate system will be set, and positions of respective members will be described with reference to this XYZ orthogonal coordinate system. A long side direction of the largest surface of the housing 2 that is a direction of a central axis 100 of the shaft 10 is a Z-axis direction, a short side direction of the largest surface of the housing 2 is an X-axis direction, and a direction that is orthogonal to the largest surface of the housing 2 is a Y-axis direction. The Z-axis direction is also a perpendicular direction. Note that hereinafter, an upper side in the Z-axis direction in FIG. 2 is an upper side of the actuator 1, and a lower side in the Z-axis direction in FIG. 2 is a lower side of the actuator 1. Furthermore, a right side in the X-axis direction in FIG. 2 is a right side of the actuator 1, and a left side in the X-axis direction in FIG. 2 is a left side of the actuator 1. Additionally, a front side in the Y-axis direction in FIG. 2 is a front side of the actuator 1, and a back side in the Y-axis direction in FIG. 2 is a back side of the actuator 1. The housing 2 is formed such that a dimension in the Z-axis direction is larger than a dimension in the X-axis direction, and a dimension in the X-axis direction is larger than a dimension in the Y-axis direction. In the housing 2, a location corresponding to one surface (a front surface in FIG. 2) orthogonal to the Y-axis direction is open, and this opening is closed with the lid 200. The lid 200 is fixed to the housing 2 with, for example, screws.

The housing 2 houses therein a rotating motor 20, a linear motion motor 30, an air control mechanism 60, and a brake device 90. The rotating motor 20 is a motor that rotates the shaft 10 about a central axis 100 of the shaft. The linear motion motor 30 is a motor that moves the shaft 10 straight in a direction along the central axis 100 (i.e., the Z-axis direction) of the shaft relative to the housing 2. Furthermore, a shaft housing 50 into which the shaft 10 is inserted is attached to a lower end face 202 of the housing 2 in the Z-axis direction. In the housing 2, a recess 202B is formed to be recessed from the lower end face 202 toward an interior of the housing 2, and a part of the shaft housing 50 is inserted into the recess 202B. A through hole 2A in the Z-axis direction is formed in an upper end of the recess 202B in the Z-axis direction, and the shaft 10 is inserted into the through hole 2A and the shaft housing 50. The tip 10A of the shaft 10 on the lower side in the Z-axis direction protrudes outward from the shaft housing 50. The shaft 10 is provided at a center of the housing 2 in the X-axis direction and a center of the housing in the Y-axis direction. That is, the shaft 10 is provided such that a central axis extending in the Z-axis direction through the center of the housing 2 in the X-axis direction and the center of the housing in the Y-axis direction is superimposed on the central axis 100 of the shaft 10. The shaft 10 is moved straight in the Z-axis direction by the linear motion motor 30 and is rotated about the central axis 100 by the rotating motor 20.

A base end 10B side of the shaft 10 that is an end on a side opposite to the tip 10A (an upper end in the Z-axis direction) is housed in the housing 2 and connected to an output shaft 21 of the rotating motor 20. The rotating motor 20 rotatably supports the shaft 10. A central axis of the output shaft 21 of the rotating motor 20 coincides with the central axis 100 of the shaft 10. The rotating motor 20 includes, in addition to the output shaft 21, a stator 22, a rotor 23 that rotates in the stator 22, and a rotary encoder 24 that detects a rotation angle of the output shaft 21. The rotor 23 rotates relative to the stator 22, and the output shaft 21 and the shaft 10 also rotate in conjunction with the stator 22.

The linear motion motor 30 includes a stator 31 fixed to the housing 2, and a mover 32 that moves relative to the stator 31 in the Z-axis direction. The linear motion motor 30 is, for example, a linear motor. The stator 31 is provided with a plurality of coils 31A, and the mover 32 is provided with a plurality of permanent magnets 32A. The coils 31A are arranged at a predetermined pitch in the Z-axis direction, and a plurality of sets of three coils 31A of U, V and W phases are provided. In the present embodiment, by passing three phase armature current through the coils 31A of the U, V and W phases for the excitation to generate a moving magnetic field, the mover 32 is linearly moved relative to the stator 31. The linear motion motor 30 includes a linear encoder 38 that detects a relative position of the mover 32 to the stator 31. The linear encoder 38 is an incremental encoder. Note that in place of the above configuration, the stator 31 may be provided with a permanent magnet, and the mover 32 may be provided with a plurality of coils.

The mover 32 of the linear motion motor 30 is coupled to the stator 22 of the rotating motor 20 via a linear motion table 33. The linear motion table 33 is movable with movement of the mover 32 of the linear motion motor 30. Consequently, the shaft 10 is connected to the mover 32 of the linear motion motor 30 via the rotating motor 20 and the linear motion table 33. Then, the shaft 10 moves in the Z-axis direction with the movement of the mover 32 of the linear motion motor 30. The movement of the linear motion table 33 is guided in the Z-axis direction by a linear motion guide device 34. The linear motion guide device 34 includes a rail 34A fixed to the housing 2, and a slider block 34B mounted to the rail 34A. The rail 34A extends in the Z-axis direction, and the slider block 34B is configured to be movable along the rail 34A in the Z-axis direction.

The linear motion table 33 is fixed to the slider block 34B and is movable together with the slider block 34B in the Z-axis direction. The linear motion table 33 is coupled to the mover 32 of the linear motion motor 30 via two coupling arms 35. The two coupling arms 35 couple opposite ends of the mover 32 in the Z-axis direction to opposite ends of the linear motion table 33 in the Z-axis direction. Furthermore, the linear motion table 33 is coupled, on a central side of the opposite ends, to the stator 22 of the rotating motor 20 via two coupling arms 36. Since the linear motion table 33 is coupled to the stator 22 of the rotating motor 20 via the two coupling arms 36, the stator 22 of the rotating motor 20 and the shaft 10 also move with the movement of the linear motion table 33. Each coupling arm 36 has a quadrangular cross section. A strain gauge 37 is fixed to a surface of each coupling arm 36 facing upward in the Z-axis direction. Note that two strain gauges 37 of the present embodiment are provided on surfaces of the coupling arms 36 facing upward in the Z-axis direction, respectively, and in place of the surfaces, the gauges may be provided on surfaces of the coupling arms 36 facing downward in the Z-axis direction, respectively. Alternatively, the strain gauge 37 may be provided only on one of the two coupling arms 36.

The brake device 90 is a device that brakes the movement of the shaft 10 in the Z-axis direction. When brake turns on, the brake device 90 is pressed onto the stator 22 of the rotating motor 20. Since the movement of the stator 22 of the rotating motor 20 in the Z-axis direction is thus braked, the movement of the shaft 10 in the Z-axis direction is also braked. Furthermore, movement of the mover 32 of the linear motion motor 30 in the Z-axis direction is also braked, with the mover being connected to the shaft 10 via the stator 22 of the rotating motor 20, the coupling arms 36, the linear motion table 33 and the coupling arms 35. Therefore, the brake device 90 stops the movements of the stator 22 of the rotating motor 20 and the shaft 10 in the Z-axis direction, so that it is also possible to stop movement of the mover 32 of the linear motion motor 30 in the Z-axis direction. When the brake turns off, the brake device 90 is spaced apart from the stator 22 of the rotating motor 20. Consequently, the movement of the stator 22 of the rotating motor 20 in the Z-axis direction is possible. Accordingly, the movements of the shaft 10 and the mover 32 of the linear motion motor 30 in the Z-axis direction are also possible.

The air control mechanism 60 is a mechanism to generate a positive pressure or a negative pressure at the tip 10A of the shaft 10. That is, the air control mechanism 60 sucks air in the shaft 10 during picking up of a workpiece W, to generate the negative pressure at the tip 10A of the shaft 10. Consequently, the workpiece W is sucked to the tip 10A of the shaft 10. Furthermore, air is supplied into the shaft 10, to generate the positive pressure at the tip 10A of the shaft 10. Thus, the workpiece W is easily removed from the tip 10A of the shaft 10.

The air control mechanism 60 includes a positive pressure passage 61A (see a dashed chain line) through which positive pressure air flows, a negative pressure passage 61B (see a double-dashed chain line) through which negative pressure air flows, and a shared passage 61C (see a broken line) shared by the positive pressure air and the negative pressure air. The positive pressure passage 61A has one end connected to a positive pressure connector 62A provided on an upper end face 201 of the housing 2 in the Z-axis direction, and the positive pressure passage 61A has the other end connected to a solenoid valve for positive pressure (hereinafter, referred to as a positive pressure solenoid valve 63A). The positive pressure solenoid valve 63A is opened and closed by an after-mentioned controller 7. Note that the positive pressure passage 61A has one end portion constituted of a tube 610, and the other end portion constituted of a hole made in a block 600. The positive pressure connector 62A extends through the upper end face 201 of the housing 2 in the Z-axis direction, and the positive pressure connector 62A is connected to an external tube linked to an air discharging pump or the like.

The negative pressure passage 61B has one end connected to a negative pressure connector 62B provided on the upper end face 201 of the housing 2 in the Z-axis direction, and the negative pressure passage 61B has the other end connected to a solenoid valve for negative pressure (hereinafter, referred to as a negative pressure solenoid valve 63B). The negative pressure solenoid valve 63B is opened and closed by the after-mentioned controller 7. Note that the negative pressure passage 61B has one end portion constituted of a tube 620, and the other end portion constituted of a hole made in the block 600. The negative pressure connector 62B extends through the upper end face 201 of the housing 2 in the Z-axis direction, and the negative pressure connector 62B is connected to an external tube linked to an air sucking pump or the like.

The shared passage 61C is constituted of a hole made in the block 600. The shared passage 61C has one end branching into two to be connected to the positive pressure solenoid valve 63A and the negative pressure solenoid valve 63B, and the shared passage 61C has the other end connected to an air flow passage 202A that is a through hole formed in the housing 2. The air flow passage 202A communicates with the shaft housing 50. The negative pressure solenoid valve 63B is opened and the positive pressure solenoid valve 63A is closed, to communicate between the negative pressure passage 61B and the shared passage 61C, thereby generating the negative pressure in the shared passage 61C. Then, air is sucked from the shaft housing 50 through the air flow passage 202A. On the other hand, the positive pressure solenoid valve 63A is opened and the negative pressure solenoid valve 63B is closed, to communicate between the positive pressure passage 61A and the shared passage 61C, thereby generating the positive pressure in the shared passage 61C. Then, air is supplied into the shaft housing 50 through the air flow passage 202A. The shared passage 61C is provided with a pressure sensor 64 that detects a pressure of air in the shared passage 61C and a flow sensor 65 that detects a flow rate of air in the shared passage 61C.

The upper end face 201 of the housing 2 in the Z-axis direction is connected to a connector 41 including a power supplying wire and a signal line. Furthermore, the housing 2 is provided with the controller 7. The wire or signal line pulled from the connector 41 into the housing 2 is connected to the controller 7. The controller 7 is provided with a central processing unit (CPU), a random access memory (RAM), a read only memory (ROM), and an erasable programmable ROM (EPROM), which are connected to one another via a bus. Various tables stored in the EPROM are loaded and executed in a work area of the RAM by the CPU, and through the execution of this program, the rotating motor 20, the linear motion motor 30, the brake device 90, the positive pressure solenoid valve 63A, the negative pressure solenoid valve 63B and others are controlled. Thus, the CPU achieves a function that meets a predetermined purpose. Furthermore, output signals of the pressure sensor 64, the flow sensor 65, the strain gauge 37, the rotary encoder 24 and the linear encoder 38 are input into the controller 7.

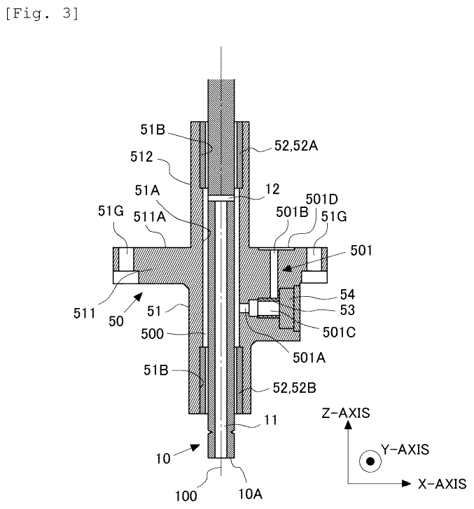

FIG. 3 is a cross-sectional view illustrating a schematic configuration including the shaft housing 50 and the tip 10A of the shaft 10. The shaft housing 50 includes a housing body 51, two rings 52, a filter 53, and a filter stop 54. In the housing body 51, a through hole 51A is formed into which the shaft 10 is inserted. The through hole 51A extends through the housing body 51 in the Z-axis direction, and an upper end of the through hole 51A in the Z-axis direction communicates with the through hole 2A formed in the housing 2. A diameter of the through hole 51A is larger than an outer diameter of the shaft 10. Consequently, a space is provided between an inner surface of the through hole 51A and an outer surface of the shaft 10. In opposite ends of the through hole 51A, enlarged parts 51B each having a hole diameter enlarged are provided. The rings 52 are fitted in two enlarged parts 51B, respectively. Each ring 52 is formed in a cylindrical shape, and an inner diameter of the ring 52 is slightly larger than the outer diameter of the shaft 10. Consequently, a space is also formed between an inner surface of the ring 52 and the outer surface of the shaft 10. Therefore, the shaft 10 is movable in the Z-axis direction in the ring 52, and the shaft 10 is rotatable about the central axis 100 in the ring 52. However, the space formed between the inner surface of the ring 52 and the outer surface of the shaft 10 is smaller than the space formed between the inner surface of the through hole 51A excluding the enlarged parts 51B and the outer surface of the shaft 10. Note that the ring 52 on the upper side in the Z-axis direction will be referred to as a first ring 52A, and the ring 52 on the lower side in the Z-axis direction will be referred to as a second ring 52B. The first ring 52A and the second ring 52B will be referred to simply as the rings 52 when the rings are not distinguished. In a material of the ring 52, for example, a metal or a resin may be used.

A protrusion 511 protruding in opposite right and left directions in the X-axis direction is formed in a central part of the housing body 51 in the Z-axis direction. In the protrusion 511, a mounting surface 511A is formed which is a surface parallel to the lower end face 202 of the housing 2, the surface contacting the lower end face 202 when the shaft housing 50 is mounted to the lower end face 202 of the housing 2. The mounting surface 511A is a surface orthogonal to the central axis 100. Furthermore, a part 512 that is a part of the shaft housing 50 on the upper side of the mounting surface 511A in the Z-axis direction is formed to fit in the recess 202B formed in the housing 2, when the shaft housing 50 is mounted to the housing 2.

The space is provided between the inner surface of the through hole 51A and the outer surface of the shaft 10 as described above. As a result, in the housing body 51, an inner space 500 is formed which is a space surrounded with the inner surface of the through hole 51A, the outer surface of the shaft 10, a lower end face of the first ring 52A, and an upper end face of the second ring 52B. Furthermore, in the shaft housing 50, a control passage 501 is formed which communicates between an opening of the air flow passage 202A formed in the lower end face 202 of the housing 2 and the inner space 500 to form an air passage. The control passage 501 includes a first passage 501A extending in the X-axis direction, a second passage 501B extending in the Z-axis direction, and a filter part 501C that is a space where the first passage 501A and the second passage 501B are connected and the filter 53 is disposed. The first passage 501A has one end connected to the inner space 500, and the other end connected to the filter part 501C. The second passage 501B has one end opened in the mounting surface 511A and aligned to be connected to the opening of the air flow passage 202A.

Furthermore, the second passage 501B has the other end connected to the filter part 501C. In the filter part 501C, the filter 53 formed in a cylindrical shape is provided. The filter part 501C is formed in a columnar space extending in the X-axis direction such that a central axis coincides with that of the first passage 501A. An inner diameter of the filter part 501C is substantially equal to an outer diameter of the filter 53. The filter 53 is inserted into the filter part 501C in the X-axis direction. After the filter 53 is inserted into the filter part 501C, an end of the filter part 501C which is an insertion port of the filter 53 is closed with the filter stop 54. The other end of the second passage 501B is connected to the filter part 501C from a side of an outer circumferential surface of the filter 53. Furthermore, the other end of the first passage 501A communicates with a central side of the filter 53. Therefore, air flowing through a space between the first passage 501A and the second passage 501B flows through the filter 53. Therefore, foreign matter is captured by the filter 53, even if the foreign matter is sucked together with air into the inner space 500, for example, when the negative pressure is generated at the tip 10A. In the one end of the second passage 501B, a groove 501D is formed to hold sealant.

In vicinities of opposite ends of the protrusion 511 in the X-axis direction, two bolt holes 51G are formed into which bolts are inserted, when the shaft housing 50 is fixed to the housing 2 by use of the bolts. The bolt holes 51G extend through the protrusion 511 in the Z-axis direction and open in the mounting surface 511A.

A hollow part 11 is formed on the tip 10A side of the shaft 10 such that the shaft 10 is hollow. The hollow part 11 has one end opened at the tip 10A. Furthermore, at the other end of the hollow part 11, a communication hole 12 that communicates between the inner space 500 and the hollow part 11 in the X-axis direction is formed. The communication hole 12 is formed to communicate between the inner space 500 and the hollow part 11, in an entire range of a stroke when the shaft 10 is moved in the Z-axis direction by the linear motion motor 30. Therefore, the tip 10A of the shaft 10 communicates with the air control mechanism 60 through the hollow part 11, the communication hole 12, the inner space 500, the control passage 501, and the air flow passage 202A. Note that the communication hole 12 may be formed in the Y-axis direction in addition to the X-axis direction.

According to this configuration, the communication hole 12 always communicates between the inner space 500 and the hollow part 11, even if the shaft 10 is at any position in the Z-axis direction when the linear motion motor 30 is driven to move the shaft 10 in the Z-axis direction. Furthermore, the communication hole 12 always communicates between the inner space 500 and the hollow part 11, even if a rotation angle of the shaft 10 is any angle about the central axis 100 when the rotating motor 20 is driven to rotate the shaft 10 about the central axis 100. Therefore, a communication state between the hollow part 11 and the inner space 500 is maintained even if the shaft 10 is in any state, and hence the hollow part 11 always communicates with the air control mechanism 60. For that reason, air in the hollow part 11 is sucked through the air flow passage 202A, the control passage 501, the inner space 500, and the communication hole 12, if the positive pressure solenoid valve 63A is closed and the negative pressure solenoid valve 63B is opened in the air control mechanism 60, regardless of the position of the shaft 10. As a result, the negative pressure can be generated in the hollow part 11. That is, the negative pressure can be generated at the tip 10A of the shaft 10, and hence the workpiece W can be sucked to the tip 10A of the shaft 10. Note that the space is also formed between the inner surface of the ring 52 and the outer surface of the shaft 10 as described above. However, this space is smaller than a space that forms the inner space 500 (i.e., the space formed between the inner surface of the through hole 51A and the outer surface of the shaft 10). Thus, in the air control mechanism 60, the positive pressure solenoid valve 63A is closed and the negative pressure solenoid valve 63B is opened, so that a flow rate of air flowing through the space between the inner surface of the ring 52 and the outer surface of the shaft 10 can be suppressed, even if air is sucked from the inner space 500. Consequently, the negative pressure at which the workpiece W can be picked up can be generated at the tip 10A of the shaft 10. On the other hand, the positive pressure can be generated in the hollow part 11, if the positive pressure solenoid valve 63A is opened and the negative pressure solenoid valve 63B is closed in the air control mechanism 60, regardless of the position of the shaft 10. That is, since the positive pressure can be generated at the tip 10A of the shaft 10, the workpiece W can be quickly removed from the tip 10A of the shaft 10.

### (Estimation of Magnetic Pole Position)

As described above, in the actuator 1, the shaft 10 moves in the Z-axis direction with the movement of the mover 32 relative to the stator 31 in the linear motion motor 30. Therefore, for performing a pick-and-place operation of the workpiece by moving the shaft 10 in the Z-axis direction, it is necessary to grasp the magnetic pole position of the mover 32 in the linear motion motor 30. However, when the mover 32 is moved to estimate the magnetic pole position of the mover 32 at the start of energization to the linear motion motor 30 as in the conventional technology and if the shaft 10 moves downward with the movement of the mover 32, there is concern that the shaft 10 may contact the workpiece that is ready to be picked up.

Alternatively, a plurality of actuators 1 may be placed to be stacked in the Y-axis direction. In this case, it is considered that if excitation is made in an unknown state of the magnetic pole position of the mover 32 in the linear motion motor 30 in each of the plurality of actuators 1, the mover 32 may move in a different direction in each actuator 1. As a result, in two adjacent actuators 1, one shaft 10 may move upward, and the other shaft 10 may move downward. In this case, there is concern that tips of the shafts 10 in the two adjacent actuators 1 interfere with each other depending on a size, a shape, and a rotating position of each shaft 10.

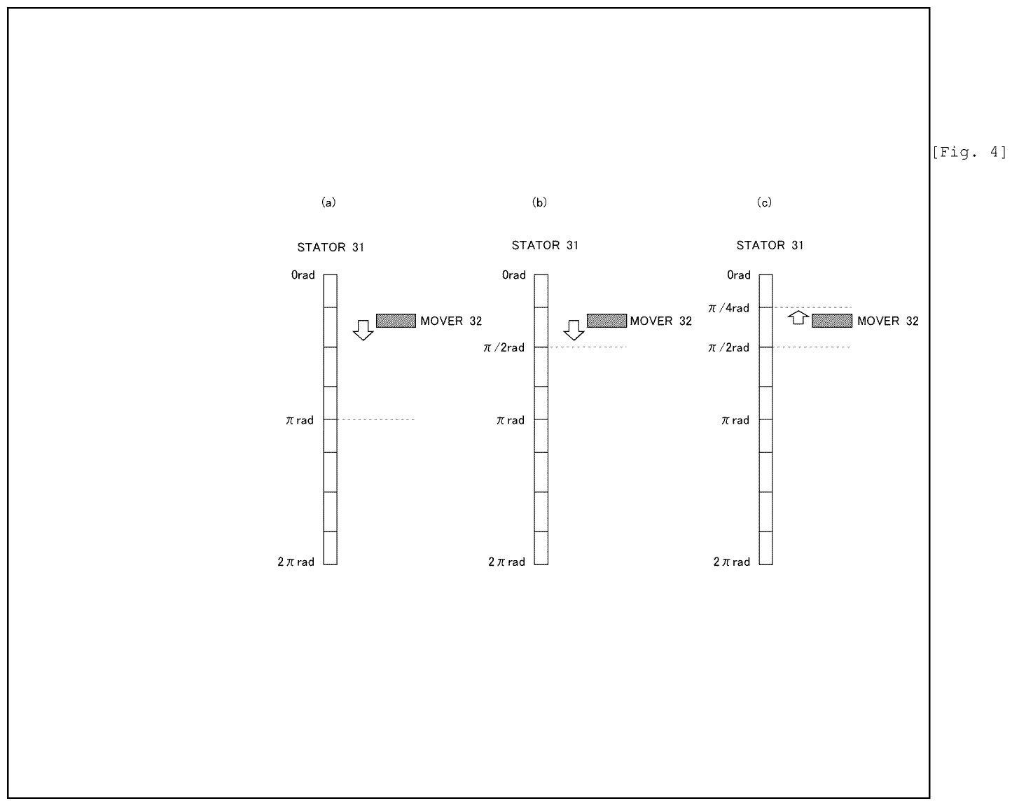

To solve such a problem, in the present embodiment, the magnetic pole position of the mover 32 in the linear motion motor 30 is estimated without moving the shaft 10. Hereinafter, a method of estimating the magnetic pole position of the mover 32 in the linear motion motor 30 according to the present embodiment will be described with reference to FIG. 4. FIG. 4 is an image diagram for explaining a method of estimating the magnetic pole position of the mover 32 in the linear motion motor 30 according to the present embodiment.

FIGS. 4(a), 4(b) and 4(c) illustrate an example of a state of the mover 32 in energizing and exciting the linear motion motor 30 in a stopped state of the movement of the mover 32 in the Z-axis direction by the brake device 90. In FIG. 4, a range of 0 rad to 2π rad in the stator 31 illustrates a movement range of the mover 32 in the Z-axis direction in the linear motion motor 30. That is, in the linear motion motor 30, the mover 32 exists at any position in the range of the magnetic pole position between 0 rad and 2π rad. Note that FIG. 4 indicates, at 0 rad, a position of an upper end of the mover 32 in the movement range in the Z-axis direction and, at 2π rad, a position of a lower end of the mover 32 in the movement range in the Z-axis direction. Also, FIG. 4 only illustrates a position of a part of the mover 32 for convenience.

Furthermore, FIG. 4 illustrates, with a white arrow, a direction of a force acting on the mover 32, when the linear motion motor 30 is energized and excited in a stopped state of the movement of the mover 32 in the Z-axis direction by the brake device 90. When energizing and exciting the linear motion motor 30 in the stopped state of the movement of the mover 32 in the Z-axis direction, strain is generated in each coupling arm 36. Then, a direction of this strain of the coupling arm 36 has a correlation with the direction of the force acting on the mover 32. Therefore, it is possible to determine the direction of the force acting on the mover 32 based on a detection value of the strain gauge 37 provided on the coupling arm 36.

In the present embodiment, the controller 7 energizes the linear motion motor 30 in a stopped state of the movements of the shaft 10 and the mover 32 of the linear motion motor 30 in the Z-axis direction by the brake device 90. Concurrently, the controller 7 first energizes the linear motion motor 30 such that the position of π rad is a first target position of the mover 32. That is, the controller energizes the linear motion motor 30 to attract the mover 32 to the position of π rad by a moving magnetic field generated in the linear motion motor 30. However, even if this energization is performed in the linear motion motor 30, the mover 32 stopped from moving in the Z-axis direction by the brake device 90 does not actually move. Therefore, the shaft 10 does not move either. Note that even in a braked state of the movement of the mover 32 in the Z-axis direction by the brake device 90, the mover 32 may move very slightly (e.g., about several micrometers) in the Z-axis direction by the moving magnetic field immediately after the energization to the linear motion motor 30. However, if a moving distance of the mover 32 in this case is very slightly, the movement of the mover 32 may be synonymous with the stopped state.

However, a force generated in the Z-axis direction by the excitation, that is, a force to attract the mover 32 to the position of aπ rad acts on the mover 32. Therefore, for example, as illustrated in FIG. 4(a), when the mover 32 is located at a section from 0 rad to π rad, the downward force acts on the mover 32. On the other hand, when the mover 32 is located at a section from π rad to 2π rad, the upward force acts on the mover 32. Then, the controller 7 determines a direction of the force acting on the mover 32 in the Z-axis direction based on the detection value of the strain gauge 37. Furthermore, the controller 7 estimates a section of the magnetic pole position at which the mover 32 exists (hereinafter, the section may be referred to as an “existence section”) based on the direction of the force acting on the mover 32. Specifically, the controller 7 estimates whether the mover 32 is located at the section from 0 to π rad or the section from π rad to 2π rad. Note that hereinafter processing performed to estimate whether the mover 32 is located at the section from 0 to π rad or the section from π rad to 2π rad may be referred to as first estimation processing.

Next, the controller 7 energizes the linear motion motor 30 such that a central position in the existence section estimated by the first estimation processing is a second target position. That is, the controller energizes the linear motion motor 30 to attract the mover 32 to the central position of the existence section by the moving magnetic field generated in the linear motion motor 30. Consequently, a force to attract the mover 32 to the central position of the existence section acts on the mover 32. Therefore, if the mover 32 is located at a section above a center in the existence section, the downward force acts on the mover 32. On the other hand, if the mover 32 is located at a section below the center in the existence section, the upward force acts on the mover 32.

For example, in the case of FIG. 4(b), the first estimation processing includes estimating the section from 0 rad to π rad as the existence section, and hence a position of π/2 rad is the second target position. As such, a force to attract the mover 32 to the position of π/2 rad acts. Therefore, as illustrated in FIG. 4(b), if the mover 32 is located at a section from 0 rad to π/2 rad, the downward force acts on the mover 32. On the other hand, if the mover 32 is located at a section from π/2 rad to π rad, the upward force acts on the mover 32. Then, the controller 7 determines the direction of the force acting on the mover 32 in the Z-axis direction, based on the detection value of the strain gauge 37 in the same manner as in the first estimation processing. Furthermore, the controller 7 estimates the existence section based on the direction of the force acting on the mover 32. Specifically, the controller 7 estimates whether the mover 32 is located at a section above a center in the existence section estimated in the first estimation processing (e.g., the section from 0 rad to π/2 rad in FIG. 4(b)) or the section below the center (e.g., the section from π/2 rad to π rad in FIG. 4(b)). Note that hereinafter, processing performed to estimate whether the mover 32 is located at a section above a center in the existence section estimated by the previous estimation processing or a section below the center may be referred to as second estimation processing.

Next, the controller 7 executes second, second estimation processing. At this time, the controller 7 energizes the linear motion motor 30 such that a central position in the existence section estimated by the first, second estimation processing is the second target position. Consequently, a force to attract the mover 32 to the central position of the existence section estimated by the first, second estimation processing acts on the mover 32. For example, in the case of FIG. 4(c), since the section from 0 rad to π/2 rad is estimated as the existence section in the first, second estimation processing, a position of π/4 rad is the second target position in the second, second estimation processing. As such, a force to attract the mover 32 to the position of π/4 rad acts. Therefore, as illustrated in FIG. 4(c), if the mover 32 is located at a section from π/4 rad to π/2 rad, the upward force acts on the mover 32. On the other hand, if the mover 32 is located at a section from 0 rad to π/4 rad, the downward force acts on the mover 32. Then, the controller 7 determines the direction of the force acting on the mover 32 in the Z-axis direction based on the detection value of the strain gauge 37, in the same manner as in the first estimation processing and the first, second estimation processing. Furthermore, the controller 7 estimates the existence section based on the direction of the force acting on the mover 32. Specifically, the controller 7 estimates whether the mover 32 is located at a section above a center in the existence section estimated in the first, second estimation processing (e.g., the section from 0 rad to π/4 rad in FIG. 4(c)) or a section below the center (e.g., the section from π/4 rad to π/2 rad in FIG. 4(c)).

Then, the controller 7 repeatedly executes such second estimation processing as described above a predetermined number of times while updating the second target position. Currently, the existence section is narrowed down each time executing the second estimation processing. As such, the second estimation processing is repeatedly executed the predetermined number of times, so that it is possible to estimate the magnetic pole position of the mover 32 with high accuracy. Note that in the present embodiment, the controller 7 corresponds to an “estimator” according to the present invention.

### (Flow of Estimation Processing)

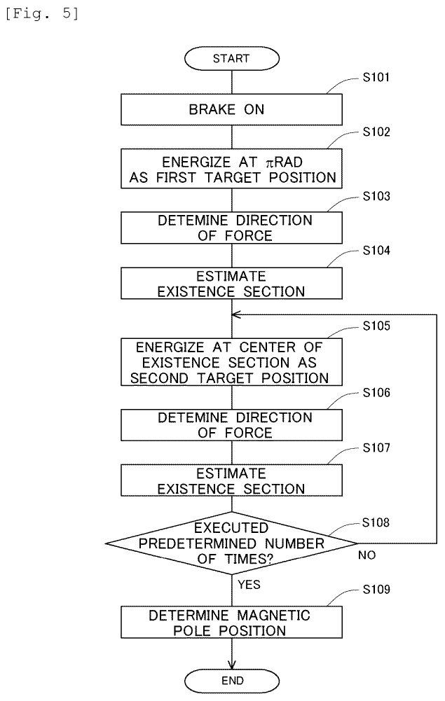

Next, flow of processing for estimating the magnetic pole position of the mover 32 in the linear motion motor 30 according to the present embodiment will be described with reference to FIG. 5. FIG. 5 is a flowchart illustrating a flow of processing of estimating the magnetic pole position of the mover 32 in the linear motion motor 30 according to the present embodiment. The controller 7 executes the present flow.

In the present flow, first, in S101, the brake device 90 is turned on. This brings a stopped state of the movement of the mover 32 in the Z-axis direction. Next, in S102, the linear motion motor 30 is energized such that the position of t rad is the first target position of the mover 32. Next, in S103, the direction of the force acting on the mover 32 in the Z-axis direction is determined based on the detection value of the strain gauge 37. Next, in S104, the existence section is estimated based on the direction of the force acting on the mover 32. That is, the controller estimates whether the mover 32 is located at the section from 0 to π rad or the section from π rad to 2π rad. A series of processing from S102 to S104 in the present flow corresponds to the first estimation processing.

Next, in S105, the linear motion motor 30 is energized such that the position of the center of the existence section estimated in S104 is the second target position. Next, in S106, the direction of the force acting on the mover 32 in the Z-axis direction is determined based on the detection value of the strain gauge 37. Next, in S107, the existence section is estimated based on the direction of the force acting on the mover 32. That is, the controller estimates whether the mover 32 is located at the section above the center of the existence section estimated in the first estimation processing of the section below the center. A series of processing from S105 to S107 in the present flow corresponds to the second estimation processing.

Next, it is determined in S108 whether the second estimation processing is performed the predetermined number of times or not. Here, the predetermined number of times is the number of times preset depending on required accuracy in estimation of the magnetic pole position of the mover 32. If determination is negative in S108, that is, if the number of times to execute the second estimation processing does not reach the predetermined number of times, the second estimation processing is executed again.

Specifically, the series of processing from S105 to S107 is executed again. In this case, in S105, the linear motion motor 30 is energized such that the central position in the existence section estimated in the previous second estimation processing is the second target position in the present second estimation processing. Also, in S107, the controller estimates whether the mover 32 is located at the section above the center of the existence section estimated in the previous second estimation processing or the section below the center.

On the other hand, if determination is affirmative in S108, processing of S109 is then executed. In S109, the second estimation processing is repeatedly executed the predetermined number of times to determine the finally estimated existence section as the magnetic pole position of the mover 32.

When determining the magnetic pole position (estimated position) of the mover 32 by the flow of the estimation processing illustrated in FIG. 5, the controller 7 executes processing for finally aligning the mover 32. This processing for alignment includes turning off the brake device 90 and energizing the linear motion motor 30 such that the magnetic pole position determined by the estimation processing is the target position. Consequently, even if an actual position of the mover 32 is slightly off the magnetic pole position determined by the estimation processing, the actual position of the mover 32 can be aligned with the magnetic pole position determined by the estimation processing. However, in the flow of the estimation processing illustrated in FIG. 5, by repeatedly executing the second estimation processing sufficient times, shift between the actual position of the mover 32 and the magnetic pole position determined by the estimation processing can be sufficiently reduced. In this case, it is unnecessary to execute the processing for the alignment after the execution of the estimation processing.

As described above, in the method of estimating the magnetic pole position of the mover 32 in the linear motion motor 30 according to the present embodiment, it is possible to estimate the magnetic pole position of the mover 32 without moving the shaft 10 in the actuator 1. Therefore, it is possible to avoid various problems caused by moving the shaft 10 to grasp the magnetic pole position of the mover 32 as in the conventional technology.

Note that in the above embodiment, the first target position in the first estimation processing is determined as the position of π rad, and the first target position is not limited to the position of π rad. That is, the first target position in the first estimation processing can be set to an arbitrary position of n rad between 0 rad and 2π rad.

Furthermore, according to the above embodiment, the first estimation processing and the second estimation processing include using the detection value of the strain gauge 37 for determining the direction of the force acting on the mover 32 in the Z-axis direction. Alternatively, the direction of the force acting on the mover 32 in the Z-axis direction may be detected by using another sensor such as a load cell.

Also, in the above embodiment, the detection value of the strain gauge 37 may be used for a purpose other than the detection of the direction of the force acting on the mover 32 in the Z-axis direction. That is, during picking up of the workpiece with the shaft 10, it may be detected, by using the strain gauge 37, that the tip 10A of the shaft 10 contacts the workpiece. Alternatively, during placing of the workpiece with the shaft 10, it may be detected, by using the detection value of the strain gauge 37, that the workpiece is grounded. When the tip 10A of the shaft 10 contacts the workpiece during the picking up of the workpiece and when the workpiece is grounded during the placing of the workpiece, strain is generated in the coupling arms 36 by the force applied to the shaft 10. This strain is detected with the strain gauge 37. Therefore, it is possible to detect, based on the detection value of the strain gauge 37, that the tip 10A of the shaft 10 contacts the workpiece during the picking up of the workpiece and that the workpiece is grounded during the placing of the workpiece.

### DESCRIPTION OF THE REFERENCE NUMERALS AND SYMBOLS

1 actuator
2 housing
10 shaft
10A tip
11 hollow part
20 rotating motor
22 stator
23 rotor
30 linear motion motor
31 stator
32 mover
36 coupling arm
37 strain gauge
50 shaft housing
60 air control mechanism
90 brake device
500 inner space
501 control passage

1. An actuator that sucks a workpiece to a tip of a shaft to pick up the workpiece, the actuator comprising:
a linear motion motor including a stator and a mover, the shaft being connected to the mover, the mover moving relative to the stator to move the shaft in an axial direction of the shaft,
a brake device that brakes the movement of the shaft in the axial direction,
a force sensor that detects a direction of a force acting on the mover in the axial direction of the shaft, and
an estimator configured to estimate a magnetic pole position of the mover, based on the direction of the force detected by the force sensor when the linear motion motor is energized in a stopped state of the movement of the shaft in the axial direction by the brake device.

2. The actuator according to claim 1, wherein the estimator executes first estimation processing and second estimation processing in the stopped state of the movement of the shaft in the axial direction by the brake device, to estimate the magnetic pole position of the mover,
the first estimation processing is processing of estimating whether the mover is located at a section from π−x rad to π rad or a section from π rad to π+πrad, based on the direction of the force detected by the force sensor when the linear motion motor is energized such that a position of n rad in a range of a magnetic pole position between 0 and 2π rad is a first target position of the mover, and
the second estimation processing is processing of estimating whether the mover is located at a section above a center in a section in which the mover is estimated to be located or a section below the center in the estimated section, based on the direction of the force detected by the force sensor when the linear motion motor is energized such that a position of the center in the estimated section is a second target position of the mover, after the execution of the first estimation processing.

3. The actuator according to claim 2, wherein the estimator estimates the magnetic pole position of the mover by repeatedly executing the second estimation processing a predetermined number of times while updating the second target position.

4. The actuator according to claim 1, wherein the force sensor includes a stain gauge,
the strain gauge is provided on a connecting member connecting the mover of the linear motion motor and the shaft, to detect strain of the connecting member.

5. A position estimation method of estimating a magnetic pole position of a mover in an actuator that sucks a workpiece to a tip of a shaft to pick up the workpiece, the actuator comprising:
a linear motion motor including a stator and the mover, the shaft being connected to the mover, the mover moving relative to the stator to move the shaft in an axial direction of the shaft,
a brake device that brakes the movement of the shaft in the axial direction, and
a force sensor that detects a direction of a force acting on the mover in the axial direction of the shaft,
the position estimation method comprising:
estimating the magnetic pole position of the mover, based on the direction of the force detected by the force sensor when the linear motion motor is energized in a stopped state of the movement of the shaft in the axial direction by the brake device.
